(19) United States
(12) Patent Application Publication
(10) Pub. No.: US 2006/0144035 A1
(43) Pub. Date: Jul. 6, 2006

(54) Photon spacecraft

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 11/027,969

(22) Filed: Jan. 3, 2005

(51) Int. Cl. F03H 1/00

(52) U.S. Cl. 60/203.1; 60/204

(57) ABSTRACT

A spacecraft propulsion system utilizing photon particles to create negative energy over the hull in order to generate a lift force on the hull.

### BRIEF SUMMARY OF THE INVENTION

This invention is a spacecraft propulsion system that employs photon particles to generate a field of negative energy in order to produce lift on the hull.

### BACKGROUND OF THE INVENTION

Referring to FIG. 1, an electromagnetic wave traveling in the z-direction consists of an electric E field vibrating in the x-direction and a magnetic flux density B field vibrating at right angles in the horizontal y-direction. The energy-stress-momentum of this photon can be analyzed using Einstein's General Theory of Relativity and the Faraday F tensor. The Faraday tensor is a 4×4 matrix containing the electromagnetic wave components as shown here in general where c is the speed of light

$${F}_{β}^{α} = \begin{matrix}t \\ x \\ y \\ z\end{matrix} \vert \begin{matrix}0 & \frac{{E}_{x}}{c} & \frac{{E}_{y}}{c} & \frac{{E}_{z}}{c} \\ \frac{{E}_{x}}{c} & 0 & {B}_{z} & - {B}_{y} \\ \frac{{E}_{y}}{c} & - {B}_{z} & 0 & {B}_{x} \\ \frac{{E}_{z}}{c} & {B}_{y} & - {B}_{x} & 0\end{matrix} \vert$$

For this particular photon, this tensor is

$${F}_{β}^{α} = \begin{matrix}t \\ x \\ y \\ z\end{matrix} \vert \begin{matrix}0 & \frac{{E}_{x}}{c} & 0 & 0 \\ \frac{{E}_{x}}{c} & 0 & 0 & - {B}_{y} \\ 0 & 0 & 0 & 0 \\ 0 & {B}_{y} & 0 & 0\end{matrix} \vert$$

The elemental spacetime length ds squared is equal to sum of the squares of the Cartesian elemental lengths
(ds)²=−(dt)²+(dx)²+(dy)²+(dz)²
The coefficients of this equation, {−1,1,1,1} are the diagonal components of the g metric tensor

$${g}_{αβ} = \begin{matrix}t \\ x \\ y \\ z\end{matrix} \vert \begin{matrix}- 1 & 0 & 0 & 0 \\ 0 & 1 & 0 & 0 \\ 0 & 0 & 1 & 0 \\ 0 & 0 & 0 & 1\end{matrix} \vert$$

The stress-energy-momentum tensor T can then be calculated for the photon using the Faraday tensor and the g metric tensor in the following equation from gravitation physics

$$4 π {T}^{μ v} = {F}^{μ α} {F}_{α}^{v} - \frac{1}{4} {g}^{μ v} {F}_{α β} {F}^{α β}$$

The stress-energy-momentum tensor indicates the curvature of space due to the application of electromagnetic fields, mass, angular momentum and charge. The mass of the Earth, for example, generates a negative curvature of spacetime such that objects fall toward the mass. The T tensor, which is also a 4×4 matrix, contains the momentum or flux terms in the first row and first column. The normal pressure stress is located along the diagonal. The shearing stresses are located off the diagonal. The energy term is in the upper left corner as depicted here,

$${T}^{μ v} = \begin{matrix}t \\ x \\ y \\ z\end{matrix} \vert \begin{matrix}energy & {flux}_{x} & {flux}_{y} & {flux}_{z} \\ - {flux}_{x} & {pressure}_{x} & {shear}_{xy} & {shear}_{xz} \\ - {flux}_{y} & {shear}_{yx} & {pressure}_{y} & {shear}_{yz} \\ - {flux}_{z} & {shear}_{zx} & {shear}_{zy} & {pressure}_{z}\end{matrix} \vert$$

Since B²=E²/c², the stress-energy-momentum tensor for the photon is therefore

$${T}_{v}^{μ} = \begin{matrix}t \\ x \\ y \\ z\end{matrix} \vert \begin{matrix}\frac{- {E}^{2}}{{c}^{2}} & 0 & 0 & \frac{+ {E}^{2}}{{c}^{2}} \\ 0 & 0 & 0 & 0 \\ 0 & 0 & 0 & 0 \\ \frac{- {E}^{2}}{{c}^{2}} & 0 & 0 & \frac{+ {E}^{2}}{{c}^{2}}\end{matrix} \vert$$

This remarkable result shows that the photon is actually a negative energy particle (top left corner) which is pushed along by a positive pressure wave (lower right corner). The particle has a positive flux (upper right corner) in the z-direction, as well as a balancing negative flux in the lower left corner so that the overall momentum of the universe remains the same. All four components cancel and we see the photon as a massless particle moving at the speed of light.

Thus the key idea behind this invention is that it is possible to cancel out the pressure term and leave a stationary vibrating electromagnetic field of negative energy over the hull of the spacecraft. The importance of negative energy is that it is a prerequisite to generating wormholes between space and hyperspace.

Hyperspace consists of the those co-dimensions which have different physics constants such as a low speed of light. The existence of hyperspace, which has a white misty look, is not a well-known scientific concept. Experiments with our magnetic vortex wormhole generators, hyperspace torque generator, full body levitation using Chi Kung breathing, arm levitation by spinning the co-gravitational K field, full body teleportation through hyperspace a distance of 100 meters using a pulsed gravitational wave, jumping into hyperspace, having a plate of toast enfold off the breakfast table and disappear into thin air, walking through walls and doors out-of-dimension, looking into other dimensions, remote viewing through subspace to distances of 100,000 light years, and other electromagnetic experiments carried out by co-researchers, have shown us the reality and existence of hyperspace.

Referring to FIG. 2, the spacecraft consists of an upper (1) and lower (2) hull attached by ceramic insulators to a circular ring (3). The ring provides support and is attached to an outer sharp-edged rim which is electrostatically charged to a potential −V. The purpose of the charged rim is to generate a radial electric E field around the vehicle.

Referring to FIG. 3, the radius of the ring (4) is equal to a. The distance from a point on the ring to the z-axis is r. The potential on the z-axis is therefore the charge divided by the distance,

$$pot Z = \frac{q}{\sqrt{{a}^{2} + {r}^{2}}}$$

This potential is expanded as a series in terms of inverse radius r

$$pot Z out = \frac{35 q {a}^{8}}{128 {r}^{9}} - \frac{5 {qa}^{6}}{16 {r}^{7}} + \frac{2 q {a}^{4}}{8 {r}^{5}} - \frac{{qa}^{2}}{2 {r}^{3}} + \frac{q}{r}$$

The potential outside the ring can be written in terms of the Legendre polynomials P

$$Vout = {\sum }_{n = 0}^{s} {( \frac{a}{r} )}^{n + 1} A [ n ] LegendreP [ n , Cos ( θ ) ]$$

where s is the number of terms in the expansion. By equating the known particular solution potZout on the z-axis with the general Vout solution, the coefficients A[n] are found to be

$$A ( 0 ) = \frac{q}{a}$$

$$A ( 1 ) = 0$$

$$A ( 2 ) = \frac{- q}{2 a}$$

$$A ( 3 ) = 0$$

which are substituted back into the Vout equation to get the potential outside the ring.

Referring to FIG. 4, the potential (dotted lines 6) looking at a slice through the ring (5) is shown together with the electric E field. The negative gradient of the potential is the electric field (7) shown by the direction of the arrows. The importance of this diagram is that the electric field points in the radial direction toward the negatively charged ring. The force on an electron is the electron charge times the electric field
F=qₑEᵣ=−|qₑ|(−|Eᵣ|)=+F
Because the electron charge is negative and the radial field points in the negative direction toward the ring, the force on the electron is positive. Thus the electron moves away from the ring in the positive radial direction. A 3-dimensional plot of the ring (8) and the electric field (9) is shown in FIG. 5.

The stress-energy-momentum generated by a radial electric field is calculated using the Faraday F tensor

$${F}_{α}^{β} = \vert \begin{matrix}0 & {E}_{r} & 0 & 0 \\ {E}_{r} & 0 & 0 & 0 \\ 0 & 0 & 0 & 0 \\ 0 & 0 & 0 & 0\end{matrix} \vert$$

The g metric tensor has to be given in spherical coordinates {r,θ,φ}

$${g}_{αβ} = \vert \begin{matrix}- 1 & 0 & 0 & 0 \\ 0 & 1 & 0 & 0 \\ 0 & 0 & {r}^{2} & 0 \\ 0 & 0 & 0 & {r}^{2} sin {( θ )}^{2}\end{matrix} \vert$$

where θ is the angle from the vertical to the radius r. The stress tensor T^{rr} along the radial direction is

$${T}^{rr} = \frac{{E}_{r}^{2}}{8 π {c}^{2}}$$

which shows that the pressure is negative along the radial line equal to the square of the radial electric field divided by the square of the speed of light. Because the field is squared, it doesn't matter that the electric field points in the negative direction. The square makes it positive, but the overall curvature pressure is negative. Thus this negative pressure cancels out the positive pressure propelling the photon along. The second key idea of the invention is how to generate this photon moving in the radial direction.

It has been known for a long time in physics that an electron moving in a circular path will emit photons in a process known by the German word Bremsstrahlung which is translated as “breaking radiation.” There are several types of radiation such as classical Bremsstrahlung involving a charged particle making a collision with another charged or uncharged particle in which photons are emitted. The quantum mechanical Bremsstrahlung involves the sudden appearance or disappearance of a charged particle which also emits radiation. In space, having a field of wormholes in which the electrons are spiraling down into hyperspace would result in the emission of photons by the quantum mechanical method. Also, in the atmosphere, having collisions with air molecules results in emission of photons in the classical way.

In order to get the electrons to spiral around and emit photons, a crossed electromagnetic field is used as shown by the following equation
F=q(Eᵣ+vᵣ×B_{θ})
where the velocity v is in the positive radial direction due to the force of the electric field. The velocity crossed with a magnetic flux density B field in the θ-direction makes the electron move sideways back and forth in a wiggling motion.

Referring to FIG. 6, a direct current solenoid (10), represented by multiple current loops, running vertically through the center of the hull, generates a magnetic field that curves around the outside of the hull, as shown by contour lines (12). The north pole (11) is at the bottom of the hull. A radial arrow (13) from the electrostatically-charged rim is perpendicular to the magnetic field lines. The cross product in the force equation becomes the electron radial velocity times the magnetic field vᵣ B_{θ}.

Referring to FIG. 7, the electric field is in the y-direction and the magnetic field is in the z-direction. The flat looping path in the x-direction is the motion of the electron. The electron, which has a negative charge, starts to move in the direction opposite to that of the electric field. In this particular diagram, the electron acquires a velocity in the negative y-direction. Then a sideways force in the x-direction is produced due to the cross product of the velocity with the magnetic field times the negative charge
−q(−v_{y}×B_{z})=+Fₓ
Depending on the magnitude of the velocity, various size loops can be produced.

In terms of the hull coordinates, because the flat loop is in the plane of the electric field which points in the radial direction, the electron emits light in the radial direction. This condition means that the negative radial pressure created by the electric field cancels the radial pressure of the photon. Thus the photon becomes a stationary vibrating quantum of negative energy. This has the appearance of a luminescent light source. The stress tensor for this condition is therefore

$${T}_{μ}^{v} = \vert \begin{matrix}- \frac{{E}^{2}}{{c}^{2}} & 0 & 0 & \frac{{E}^{2}}{{c}^{2}} \\ 0 & 0 & 0 & 0 \\ 0 & 0 & 0 & 0 \\ - \frac{{E}^{2}}{{c}^{2}} & 0 & 0 & 0\end{matrix} \vert = - \frac{{E}^{2}}{{c}^{2}} residual negative energy$$

residual negative energy
   which leaves a residual negative energy per photon.

Referring to FIG. 8, the negatively charged rim (14) produces a radial electric field (16) that crosses the magnetic B field (15) of the solenoid. Electrons emitted by the charged rim then encounter this crossed field which makes them spiral (17) around the hull. Because of the tight loop, the electron emits Bremsstahlung radiation in the radial direction (18). The positive pressure field of the photon, which is directed in the radial direction, is canceled by the negative pressure field (19) created by the electric field. Because the photon energy is negative, a stationary vibrating electromagnetic quantum of negative energy (20) surrounds the hull.

This negative energy and the pressure stress created by the electromagnetic fields open up wormholes between space and hyperspace. The potential head is positive from hyperspace into space because the energy of hyperspace is more positive than the negative energy field. The low-density hyperspace energy fills the hull and its surrounding space with a white misty hyperspace energy which makes the spacecraft lighter in mass, and therefore lighter in weight within a gravitational field. The actual physics is more complicated still because the electrons find that the resistance of hyperspace is lower than the resistance of space. Thus they spiral down the wormholes which results in a sudden disappearance of charge. The quantum mechanical effect of this is to radiate even more photons which in turn produce even more negative energy.

The lift on the hull is generated by the radial electric field. In cylindrical coordinates, the g metric tensor is

$${g}_{αβ} = \vert \begin{matrix}- 1 & 0 & 0 & 0 \\ 0 & 1 & 0 & 0 \\ 0 & 0 & {r}^{2} & 0 \\ 0 & 0 & 0 & 1\end{matrix} \vert$$

Using this metric tensor, the pressure stress in the vertical direction T^{zz} is

$${T}^{zz} = \frac{{E}^{2}}{8 π {c}^{2}}$$

which is a positive curvature over the hull. The mass of Earth produces a negative curvature in which objects fall toward the mass. By counteracting this negative curvature with a more than positive curvature, lift is developed on the spacecraft. Because the negative energy lowers the effective mass of the vehicle, the acceleration is large with a modest electric field. Moreover, in our dimension, the speed of light is 299792458 meters per second. Hyperspace energy has a speed of light equal to one meter per second. Thus the stress is amplified by a factor of

$$A = {( \frac{299792458 m / s}{1 m / s} )}^{2} \approx 9 \cdot {10}^{16}$$

Because electromagnetic fields are relativistic, motion in a low-velocity-of-light energy field amplifies their strength.

### SUMMARY OF THE INVENTION

It is the object of this invention to create a spacecraft propulsion system that produces wormholes between space and hyperspace using negative energy in order to generate lift on the hull. It was discovered in the Riemannian curvature calculations of gravitation physics that negative energy is required to keep open the throat of the wormhole. From experiments with the magnetic vortex wormhole generator, it is known that the proper combination of electromagnetic fields, together with this negative energy, can create a wormhole through which smoke can be blown into hyperspace.

Referring to FIG. 9, the directions of force, velocity, and electromagnetic fields are referred to in the cylindrical coordinate system {r,θ,z}. An electrostatically charged sharp-edged ring in the θ-direction around the hull of the spacecraft produces a radial electric field. A vertical solenoid in the z-direction through the center of the hull produces a magnetic field which is perpendicular at the rim to the electric field. With the current in the solenoid flowing in the clockwise (−θ) direction, using the right-hand rule, the magnetic field points in the upward z-direction outside the rim. Because the rim is charged to a negative voltage, the electric field points toward the hull in the negative radial (−r) direction. Electrons emitted by the rim travel outward (+v) because the charge on the electron is negative which, together with the negative electric field, produces a positive radial force. The radial force on the electron causes it to acquire a velocity which interacts with the magnetic field. The cross product of the velocity (+v) with the positive (+B) magnetic field produces a sideways force on the electron in the negative θ-direction. However, because the charge on the electron is negative, the force is
F=−q{vᵣ0,0}×{0,0,B_{z}}={0,qB_{z}vᵣ,0}
which is positive in the θ-direction. It is this sideways force that produces a flat spiraling or looping motion whereby the electron emits photons, known in German as Bremsstahlung radiation, in the radial direction. The photon, which is actually a quantum of negative energy, has a positive radial pressure which propels it along. Because the radial electric field produces a negative pressure in the radial direction, the two opposite fields cancel in the radial direction to form a residual stationary vibrating negative energy. Thus the hull becomes surrounded by negative energy which, together with the pressure stresses created by the electric field, generates wormholes between space and hyperspace.

The gravitational potential between hyperspace and space is positive because the hyperspace energy is more positive than the negative energy around the hull. Thus the low-density, low-speed-of-light hyperspace energy flows through the wormhole and fills the hull. This has the effect of reducing the effective mass of the hull. Because the electric field generates a positive pressure over the hull in the vertical z-direction, there is an upward force on the vehicle due to the pressure times the hull area. Since the vehicle has a low mass, there is a modest upward acceleration on the spacecraft equal to the force divided by mass.

### A BRIEF DESCRIPTION OF THE DRAWINGS

FIG. 1. Perspective view of an electromagnetic wave.

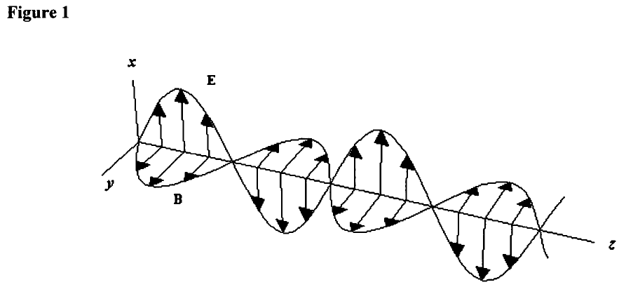

FIG. 2. Perspective view of spacecraft.

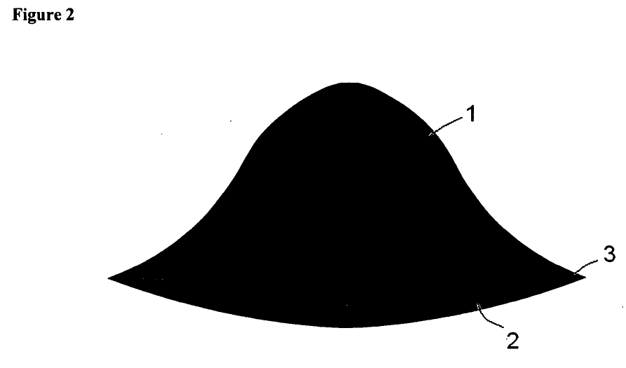

FIG. 3. Perspective view of charged ring.

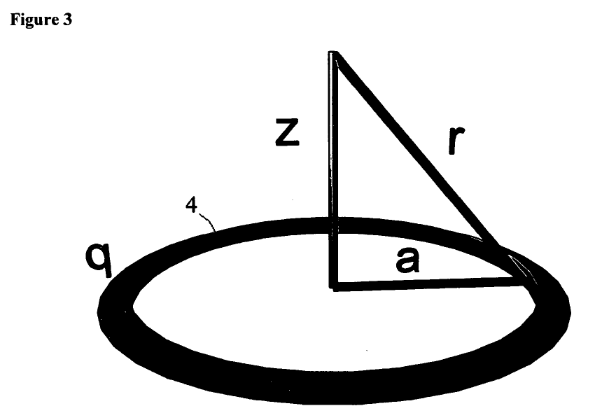

FIG. 4. Planar plot of the radial electric field produced by charged ring.

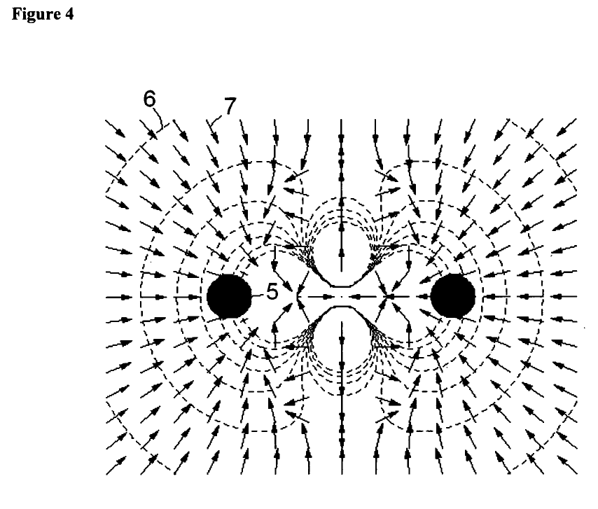

FIG. 5. Perspective view of radial electric field around ring.

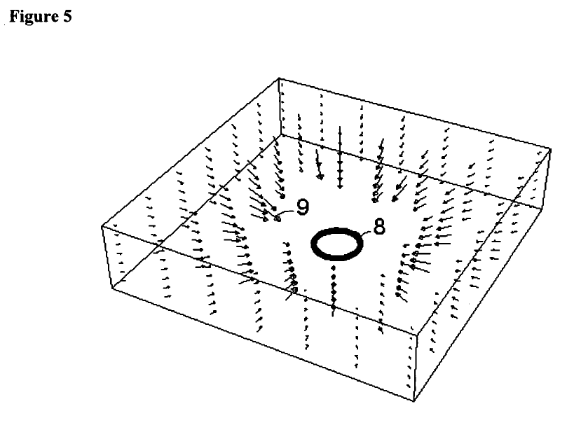

FIG. 6. Planar view of magnetic flux density field contour lines.

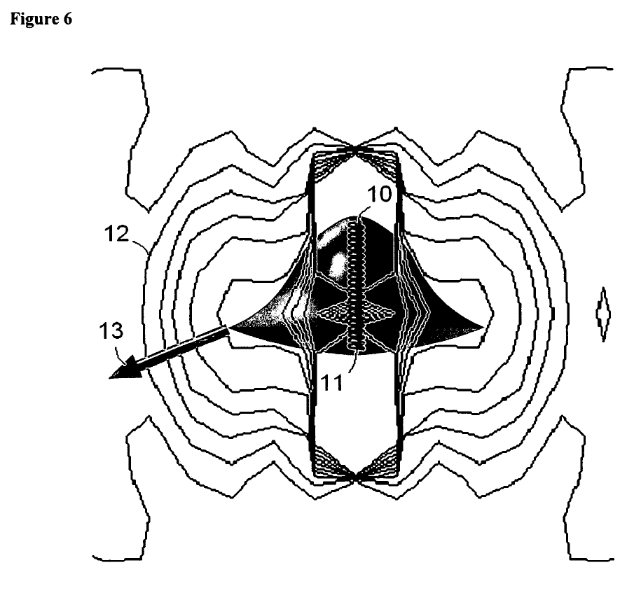

FIG. 7. Perspective view of electron motion in crossed electric and magnetic fields.

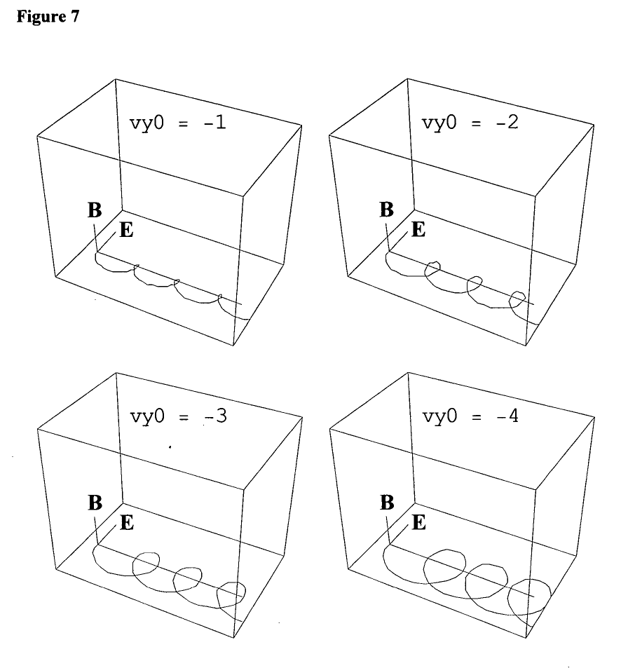

FIG. 8. Perspective view of production of negative energy around hull.

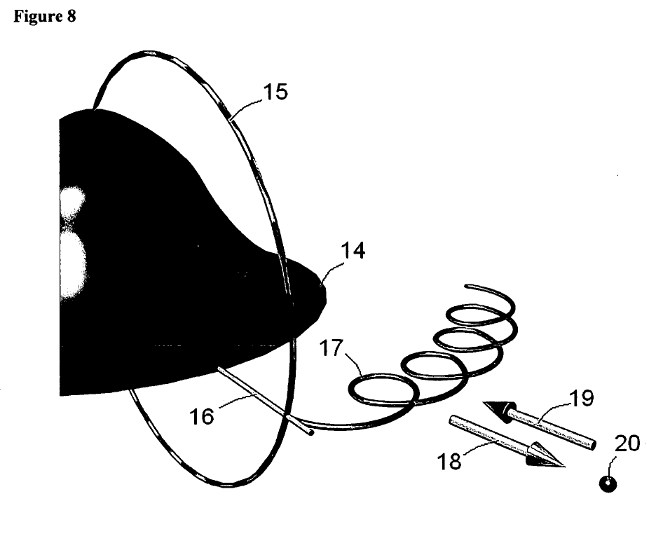

FIG. 9. Perspective view of cylindrical coordinate system {r,θ,z}.

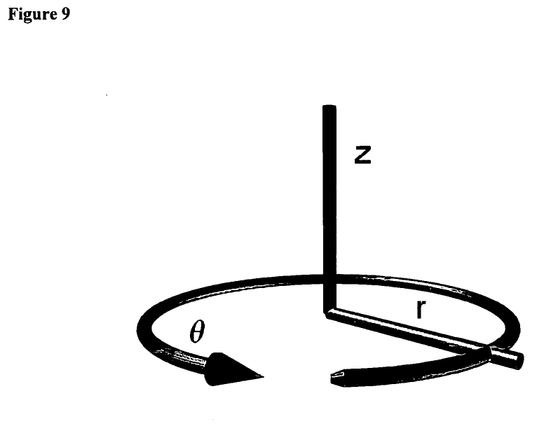

### DETAILED DESCRIPTION OF THE INVENTION

1. The hull is made from a single sheet of aluminum which has been stretched to its yield point by hydraulic cylinders. An upper and lower die is CNC machined to the profile of the hull. The soft sheet is then clamped in the die where it takes on the smooth shape of the hull without any wrinkles. The hull is extremely rigid after forming and does not require any structural reinforcements.
2. A section of the aluminum ring is made in a 3D computer graphics program. The model is stored as a stereolithography file (*.stl). The computer model is then sent via Internet e-mail to the stl server who prints the part in an ultraviolet light-cured polymer. The part is returned the next day by Express Mail. Using a rubber blanket mold to create several ring sections, the entire ring is assembled together in another wooden mold box having thin circular laminate-coated particulate wall boards on either side of the ring. Then a liquid rubber mold is poured on top of the ring and allowed to harden overnight at room temperature. Since the rubber mold is flexible, the ring can be extracted fairly easily. This ring model is then sent to the foundry where it is cast in aluminum using the lost wax process in which a wax mold evaporates out of the sand casting. We are also experimenting with non-magnetic copper casting metals containing beryllium having good conductivity.
3. A 11.5 cm plastic pipe is mounted on a rotating fixture driven slowly by a microcontoller, stepper motor, and power electronics board. Using a large diameter insulated wire, such as a 17 AWG with a wire diameter of 0.127 cm, the wire is wound slowly on the pipe and expoxied so that the windings don't come loose. The solenoid is then mounted vertically in the hull supported by the support ring and driven by a current generator located nearby on the test rig.
4. The ring is driven by a high voltage electrostatic generator similar to the night vision scope high voltage power supplies. The ring charge is isolated from the hull by ceramic insulators.

I claim:

1. A spacecraft propulsion system comprising the components:
an aluminum horizontal circular structural support ring;
an aluminum hull in the shape of a high dome on top and shallow dome on the bottom attached to the circular support ring using ceramic insulators;
an electrostatically negatively-charged sharp-edged circular ring, preferably of non-magnetic aluminum or copper, attached with ceramic insulators to the outside of the support ring;
a solenoid mounted through the center of the hull in the vertical direction and attached to the center of the support ring;
an electrostatic high-voltage generator to drive the outer electrostatic ring; and
a direct high-current generator to drive the solenoid.

2. The method of claim 1, wherein a negative radial electric field is generated around the hull by placing a negative potential on the sharp-edged electrostatic ring using the electrostatic generator.

3. The method of claim 1, wherein the current-driven solenoid generates a vertical magnetic field around the hull with the north pole of the solenoid facing down through the bottom of the hull which causes the magnetic flux density field to point up outside the rim.

4. The method of claim 1, wherein electrons are emitted radially by the sharp edge of the charged ring.

5. The methods of claims 2, 3 and 4, wherein the crossed electromagnetic fields cause the electrons to spiral around in flat loops during which photons are emitted in the radial direction.

6. The methods of claims 2 and 5, wherein the negative radial pressure created by the electric field cancels the positive radial pressure of the photon to leave a residual quantum of negative energy per photon around the hull.

7. The methods of claims 2 and 6, wherein the pressure stress created by the electric field, and the negative energy combine to form wormholes between space and hyperspace.

8. The method of claim 7, wherein low-density hyperspace energy of a higher gravitational potential flows through the wormholes to fill the hull and surrounding space around the hull with the effect of reducing the effective mass of the spacecraft.

9. The method of claim 2, wherein the electric field generates a positive pressure in the vertical direction over the hull which together with the hull surface area, generates an upward lift force on the hull.

10. The method of claim 6, wherein the negative energy, having a low light speed, amplifies the strength of the electromagnetic fields and pressure stress fields.

11. The methods of claims 4 and 7, wherein the electrons spiral down the low resistance wormholes into hyperspace such as to create a sudden disappearance of electrical charge which quantum mechanically causes a large emission of additional photons.
